(19) United States
(12) Patent Application Publication
(10) Pub. No.: US 2013/0103813 A1
(43) Pub. Date: Apr. 25, 2013

(54) Handling of HTTP Video Streams

(71) Applicant: Navin Kukreja, Bangalore (IN)

(72) Inventor: Navin Kukreja, Bangalore (IN)

(21) Appl. No.: 13/278,023

(22) Filed: Oct. 20, 2011

(51) Int. Cl. G06F 15/16

(52) U.S. Cl. 709/223

(57) ABSTRACT

According to one embodiment, a network device examines content-type fields of a Hypertext Transfer Protocol (HTTP) response message in response to a request for a selected content type. Thereafter, the priority level and/or the quality of service (QoS) level of communications is modified during transmission of a data stream having the selected content type.

### BACKGROUND OF THE INVENTION

The present invention relates to digital networks, and more particularly, to the problem of managing HTTP content such as video streams in a network.

Data networks, particularly IEEE 802.3 wired Ethernet and IEEE 802.11 wireless data networks have become an expected or necessary resource. Once present only in the workplace environment, they are now nearly ubiquitous, present in schools, libraries, retail environments, and just about anyplace where people gather.

As the use of these networks moves from a business and data focus to a more consumer and entertainment oriented focus, the static web pages of yesterday are being overwhelmed by mixed media streams, particularly video. Many web services exist for sharing and distributing video, such as YouTube, Hulu, Netflix, and more.

Using such services, users point their web browsers at a video site and select a video or multimedia stream to view. Clicking on a object starts the streaming.

Delivering video to a client is different from delivering a document such as a PDF file, a text file, static images, or other web pages. With a large static image or a very large PDF document, having individual packets making up the file arrive out of order, having packets retransmitted, or having varying delays between the arrival of packets is irrelevant. With a video or multimedia stream, however, packet loss or retransmission, delays, or jitter, which is the variation in arrival of packets, all effect the quality of playback.

What is needed is a better way to handle video and multimedia traffic in the network environment, particularly in the wireless environment.

### BRIEF DESCRIPTION OF THE DRAWINGS

The invention may be best understood by referring to the following description and accompanying drawings that are used to illustrate embodiments of the invention in which:

FIG. 1 shows devices in a network,

### DETAILED DESCRIPTION

Embodiments of the invention relate to methods of handling media streams on a network. A network device scans HTTP responses to clients, the network device searching these responses for content-type fields identifying streams or content of interest. When such content is identified, the network device alerts other network devices and/or services to change the priority and/or Quality of Service (QoS) for the session containing the stream. Detection may be made by network switches, network controllers, or wireless access points.

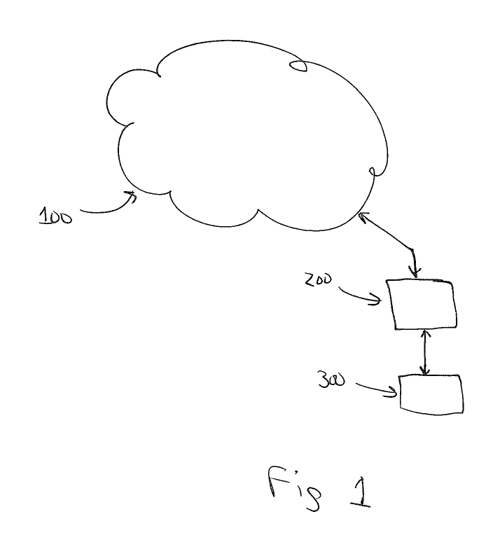

According to the present invention and as shown in FIG. 1, network device 200 receives streams from network 100 to client 300.

As is understood in the art, network device 200 is a purpose-built digital device containing a processor, a memory hierarchy, and input/output interfaces. Such devices typically operate under the control of an operating system such as Linux, running specific programs to provide for access point operation. A MIPS-class processor such as one from Cavium or NetLogic—RMI may be used. Wired network interfaces typically are IEEE 802.3 Ethernet interfaces. Wireless interfaces are typically IEEE 802.11 WiFi interfaces. The memory hierarchy of the device typically contains fast read-write memory for holding programs and data during device operation, and a hierarch of persistent memory such as ROM, EPROM, and Flash for holding instructions and data needed for device startup, and a file system for device operation.

Client device 300 is also a digital device containing a processor, memory hierarchy, and input/output interfaces, including a wireless interface such as an IEEE 802.11 wireless interface for communicating with network device 200. Typical client devices 300 include but are not limited to laptop and netbook computers, wireless phones, wireless music players, and the like.

For clarity, FIG. 1 does not show other typical network devices such as switches, routers, firewalls, and the like which are well understood by the art.

According to the present invention, network device 200 examines HTTP responses from network 100 to client 300. It is understood that a single network device 200 may be examining multiple streams to multiple clients 300. Techniques known to the art such as deep packet inspection may be used.

Typically a program such as a browser on client device 300 sends an HTTP GET request to a service in network 100. The response to client 300 is a HTTP 200 response message. This message contains a content-type field identifying the container format being used.

As is understood in the art, HTTP response messages in the 200 range indicate success, and are herein referred to as HTTP response messages, of which HTTP 200 OK is one such message.

According to the present invention, network device 200 examines HTTP response messages to clients 300 for particular content-type fields indicating contents of interest.

As an example, for video or multimedia streams, the content-type field contains a MIME type indicating a video stream. Video MIME types include, but are not limited to video/mpeg, video/mp4, video/ogg, video/quicktime, video/webm, video/x-ms-wmv, video/x-ms-asf, and others.

In an aspect of the invention, when network device 200 encounters an HTTP response message to a client identifying a session as a video or multimedia stream, network device 200 signals other devices and/or processes in the network that the session is a multimedia or video stream and should be given priority.

In another aspect of the invention, the process of scanning HTTP response messages to clients may also be performed in an access point (AP), switch, router, controller, or other network device. As an example, an AP may examine streams for its associated clients, and when the AP detects a content-type of interest, such as a multimedia stream, the AP may adjust the priority or QOS of that session as transmitted to the client.

In response to this identification, other network devices such as switches, routers, controllers, and/or wireless access points may give priority to the identified session. This may be done by altering the Quality of Service (QoS) associated with the session, or by other approaches to give priority to the identified session. Other content interest may also include audio streams.

It should be understood that the process of scanning streams to clients may be performed on a stand-alone network device, or the process may be performed in other devices on the network such as switches, routers, controllers, or access points.

In another aspect of the invention, the scanning of HTTP response messages for content-type fields of interest may be performed on a per-user basis, or on the basis of per-user rules.

In another aspect of the invention, the scanning of HTTP response messages for content-type fields of interest may be used to lower the priority or QoS applied to certain media types, or to drop certain types altogether. As an example, a lower QoS may be applied to Flash (x-shockwave-flash), or to block Javascript. During certain periods of the day, or in certain locations, a lower priority or QoS may be applied to video or multimedia streams to discourage their use.

This process may be applied on all traffic, only to traffic for a selected group of clients, or on a per-user basis. Clients may be grouped, for example, based on VLAN, SSID, access point, address range, or other characteristics.

The present invention may be realized in hardware, software, or a combination of hardware and software. A typical combination of hardware and software may be a network server or access point with a computer program that, when being loaded and executed, controls aspects of the host device such that it carries out the methods described herein.

The present invention also may be embedded in nontransitory fashion in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

1. A method of managing traffic to clients on a digital network comprising:
examining, at a network device, a Hypertext Transfer Protocol (HTTP) response message for a selected content type;
identifying, at the network device, a data stream with the selected content type; and
modifying, at the network device, the data stream upon determining that the data stream has the selected content type.

2. The method of claim 1, wherein the modifying of the data stream includes increasing a priority of the data stream.

3. The method of claim 1, wherein the change to the handling of the modifying of the data stream includes lowering a priority of the data stream.

4. The method of claim 1, wherein the modifying of the data stream includes dropping the data stream based on the data stream being the selected content type.

5. The method of claim 1, wherein the selected content type is a multipurpose Internet Mail Extensions (MIME) type indicating a video stream.

6. The method of claim 1, wherein the selected content type is Flash.

7. The method of claim 1, wherein the selected content type is Javascript.

8. The method of claim 1, wherein the identifying of the data stream and modifying the data stream is applied on a per-user basis.

9. The method of claim 1, wherein the network device is a switch, controller, or router.

10. The method of claim 1, wherein the network device is an access point (AP).

11. The method of claim 1, wherein the modifying of the data stream further includes increasing a Quality of Service (QoS) of the data stream.

12. The method of claim 10, wherein the examining of the HTTP response messages, the identifying of the data stream, and the modifying of the data stream are applied for a subset of clients in communications with.

13. The method of claim 10, wherein the examining of the HTTP response messages, the identifying of the data stream, and the modifying of the data stream are applied on a per-client basis for clients in communications with the AP.

14. A non-transistory machine readable medium having a set of instructions stored in a memory which when executed on a network device which are part of a network, causes a set of operations to be performed comprising:
examining a Hypertext Transfer Protocol (HTTP) response message for a selected content type:
a data stream with the selected content type; and
modifying the data stream upon determining that the data stream has the selected content type.

15. The machine readable medium of claim 14 where the network device is an access point (AP).

16. A method comprising:
examining, at a network device, a Hypertext Transfer Protocol (HTTP) response message in response to a request for a selected content type; and
modifying, at the network device, one of a priority level and a quality of service (QoS) level of communications during transmission of a data stream having the selected content type.

17. The method of claim 16, wherein the modifying of the one of the priority level and the QoS level includes increasing the priority level of the communications for transmitting the data stream.

18. The method of claim 16, wherein the modifying of the one of the priority level and the QoS level includes lowering the priority level of the communications for transmitting the data stream.

20. The method of claim 16, wherein the modifying of the one of the priority level and the QoS level is performed on a per-user basis.
